(19) United States
(12) Patent Application Publication
(10) Pub. No.: US 2023/0288009 A1
(43) Pub. Date: Sep. 14, 2023

(54) DEVICE AND METHOD FOR ACTIVELY REDUCING PRESSURE VARIATIONS IN A HYDRODYNAMIC SYSTEM

(71) Applicant: UNIVERSITÄT ROSTOCK, ROSTOCK (DE)

(72) Inventors: JOHANNES BÜKER, OSTSEEBAD NIENHAGEN (DE); ANDRÉ LASS, ROSTOCK (DE)

(21) Appl. No.: 18/018,553

(22) PCT Filed: Jul. 29, 2021
(86) PCT No.: PCT/EP2021/071280

§ 371 Date: Jan. 28, 2023

(30) Foreign Application Priority Data
Jul. 31, 2020 (DE) 10 2020 209 681.3

(51) Int. Cl. F16L 55/033; F04B 11/00; F04D 15/00; F16L 55/05

(52) U.S. Cl. CPC F16L 55/0333; F04B 11/00; F04D 15/0083; F16L 55/05; F15B 21/008

(57) ABSTRACT

The invention relates to a device for active reduction of pressure fluctuations in a hydrodynamic system comprising a pump, a pressure fluctuation generator and at least one pressure sensor, and a controller unit. The controller unit is adapted to control the pressure fluctuation generator and to receive a pressure fluctuation signal from the pressure sensor. Furthermore, the present invention relates to a corresponding method and a pressure fluctuation generator for a corresponding device.

The present invention relates to a device for active reduction of pressure fluctuations in a hydrodynamic system comprising a pump, a pressure fluctuation generator and at least one pressure sensor and a controller unit. The controller unit is adapted to control the pressure fluctuation generator and to receive a pressure fluctuation signal from the pressure sensor. Furthermore, the present invention relates to a corresponding method and a pressure fluctuation generator for a corresponding device.

Hydrodynamic systems may be open or closed systems in which the active components are connected by means of pipelines, resulting in a piping system in the hydrodynamic system. Hydrodynamic systems are implemented, for example, in water supply, heating and/or air conditioning systems.

In hydrodynamic systems, pressure changes can be introduced into the hydrodynamic system in particular by the active components, such as hydrostatic and hydrodynamic flow machines, whose purpose is fluid transport, as well as valves, such pressure changes propagate in waves in the hydrodynamic system as pressure fluctuations or pressure pulsations at the speed of sound and are reflected or absorbed at locations with an abrupt change in acoustic impedance, for example walls, valves or silencers. The energy transported with the pressure wave is thereby impressed on and transmitted to the mechanical structure, which in particular also includes pipelines. This causes the structure of the hydrodynamic system to vibrate, depending on its structural-dynamic properties. These vibrations lead to vibrations of the surrounding structure and can have a negative effect on neighboring processes.

In addition, these vibrations can lead to the emission of airborne sound into the environment, which can be perceived as disturbing noise. This problem occurs in technical plants in chemical and process engineering, water supply and especially in heating systems in residential buildings.

In addition to acoustic effects, the pressure fluctuations introduced can cause undesirable shocks in the hydrodynamic system. Furthermore, pressure fluctuations result in increased system resistance due to additional frictional effects, which has a negative effect on the overall resistance of the hydrodynamic system.

In principle, devices for reducing pressure fluctuations in hydraulic or hydrodynamic systems are known in the field of hydroacoustics, e.g. from “Hybrid Fluid-borne Noise Control in Fluid-filled Pipelines” M Pan et al 2016 J. Phys.: Conf. Ser. 744 012016.

It is therefore a task of the present invention to disclose an improved device and method for active reduction of pressure fluctuations in a hydrodynamic system, as well as a pressure fluctuation generator for such a device.

The invention solves this problem with the features of the independent claims. Further preferred embodiments of the invention can be found in the dependent claims and the accompanying descriptions and drawings.

According to the basic idea of the application, a device for active reduction of pressure fluctuations in a hydrodynamic system with a pump, a pressure fluctuation generator, at least one pressure sensor and a controller unit is proposed. The controller unit is adapted to control the pressure fluctuation generator and to receive a pressure fluctuation signal from the pressure sensor. It is proposed that the rotational speed of the pump can be captured and is receivable by the controller unit, wherein the controller unit is adapted to generate a reference signal from the rotational speed of the pump, to generate a control signal from the reference signal by means of an adaptive filter, and to control the pressure fluctuation generator with the control signal. The controller unit is adapted to continuously optimize the adaptive filter to minimize the pressure fluctuation signal.

The pump has been identified as a major source of the pressure fluctuations, which appear as dynamic changes or pulses in the temporal course of the pressure, in the hydrodynamic system, wherein the frequency or frequencies of these pressure fluctuations are dependent on the rotational speed and type of the pump, for example. The pump is a hydrodynamic pump or fluid machine. Hydrodynamic pumps can be, for example, side-channel, radial-flow, and axial-flow pumps, especially circulating pumps. The focus of hydrodynamic pumps is to supply fluid volume flow. The pressure fluctuations or pressure oscillations represent unwanted losses and excitations.

The pressure fluctuations are preferably measured downstream of the pump by a pressure sensor and converted into a pressure fluctuation signal, which is received by the controller unit. The pressure fluctuation signal is variable in time corresponding to the pressure fluctuations present, which occur in particular in the pipelines of the hydrodynamic system. The pressure sensor is preferably located downstream of the pump and the pressure fluctuation generator.

The pressure fluctuations comprise dynamics in pressure over time, which are superimposed on the static pressure in the hydrodynamic system. Static pressure can therefore also be understood as an average or mean pressure around which the pressure fluctuations vary.

The rotational speed of the pump can be detected, for example, by means of a rotational speed sensor. Furthermore, in the case of electrically driven pumps, the rotational speed can be captured directly from the electrical control of the pump under certain circumstances, so that the rotational speed of the pump can be received as a variable measurand by the controller unit.

In addition to this variable measurand, in preferred embodiments a constant quantity of the pump, in particular the number of impeller blades or rotor blades and/or guide vanes, is present on the controller unit.

The reference signal is generated in the controller unit and preferably comprises at least one sinusoidal oscillation whose frequency, in preferred embodiments, corresponds to an integer multiple of the rotational speed. The amplitude of the sinusoidal oscillation in the reference signal preferably has a preset value. The reference signal may comprise further sinusoidal oscillations whose frequencies preferably again correspond to an integer multiple of the first frequency. The further sinusoidal oscillations preferably comprise a smaller preset amplitude than the first sinusoidal oscillation. The reference signal is thus generated as a function of the captured rotational speed of the pump and is thus subject to the same temporal changes as the rotational speed of the pump.

The reference signal generated accordingly is filtered by means of a filter, in particular a digital filter, in the controller unit. Preferably, a finite impulse response (FIR) filter is used, which is implemented in the controller unit. The filter comprises corresponding filter parameters which can change amplitudes, phase position and/or frequencies of the reference signal. The reference signal is referred to as the control signal after passing through the filter.

The provided filter, in particular the FIR filter, is adaptive, so that the filter behavior can be changed during operation, in particular by adjusting the filter parameters.

The pressure fluctuation generator is controlled and operated with the control signal, which in advantageous embodiments is additionally amplified. The pressure fluctuation generator generates longitudinal pressure waves by using an oscillating source area of the oscillator. The pressure fluctuation generator may be, for example, a hydrostatic actuator. The pressure waves or pressure fluctuations preferably first travel longitudinally along a connecting pipe of the hydrodynamic system in which the pressure fluctuation generator is positioned, before they interfere with the other pressure fluctuations in the system. The source area is preferably planar. However, the source area can also be designed in a non-planar manner.

In advantageous embodiments, the connecting pipe in which the pressure fluctuation generator is preferably arranged is connected to the hydrodynamic system via a connecting piece. The geometric design of the connecting piece may vary depending on the application. For example, the connecting piece may be designed as an angled T- or Y-piece or arc-shaped piece. The cross-section of the connecting pipe can also vary depending on the application. Preferably, the pressure fluctuations in the hydrodynamic system, in particular from the pump, are superimposed on the pressure fluctuations of the pressure fluctuation generator in the connecting piece, wherein the pressure fluctuations in the hydrodynamic system can be minimized by destructive interference.

The effect of interference from the pressure fluctuations of the hydrodynamic system respectively the pump with the pressure fluctuations of the pressure fluctuation generator can be measured with the pressure sensor downstream of the pump, which captures the pressure fluctuations and generates a corresponding pressure fluctuation signal, which is transmitted to the controller unit.

An optimization process is continuously carried out in the controller unit, in which the pressure fluctuation signal is minimized as the target variable by adjusting the filter parameters of the adaptive filter. The filter parameters change the control signal, resulting in a changed superposition or interference of the pressure fluctuations, which changes the pressure fluctuation signal accordingly and enables the optimization process.

Accordingly, after an optimization phase, the adaptive filter adjusts itself so that the reference signal is adjusted or changed in such a way that the interference of the pressure fluctuations is as destructive as possible. This reduces the pressure fluctuations in the hydrodynamic system, which in turn leads to lower acoustic emission and lower resistance in the hydrodynamic system.

In particular, the proposed device for active reduction of pressure fluctuations enables automatic adaptation to changes in the hydrodynamic system, for example by opening or closing individual valves in the hydrodynamic system, through the continuous optimization process. Furthermore, a change in the rotational speed of the pump can take place immediately due to the direct consideration in the reference signal, without having to wait for the optimization phase to adapt to the changed system due to the changed rotational speed. Therefore, a change in the rotational speed of the pump does not necessarily result in a significant adjustment of the filter parameters, so that the optimization phase until an optimum is reached is significantly shortened. Due to the continuous optimization, a change in the rotational speed of the pump and thus a change in the reference signal results in an adaptation on the one hand due to the changed reference signal and on the other hand due to the continuous optimization or adaptation of the filter.

According to a further development, it is proposed that the pump comprises a constant number of blades, wherein the controller unit is adapted to generate a reference signal comprising a first amplitude peak at a first frequency corresponding to the speed multiplied by the number of blades. The blade number can also describe the number of rotors of a pump.

In this way, the reference signal can already be generated as similar as possible to the subsequent control signal. The reference signal thus preferably comprises a sinusoidal oscillation at the frequency of the blade passing frequency of the pump. The blade passing frequency corresponding to the rotational speed multiplied by the number of blades is also referred to as the first blade passing frequency.

In a further advantageous development, it is proposed that the controller unit is adapted to generate a reference signal comprising, in addition to the first amplitude peak at the first frequency, at least one further amplitude peak at a further frequency, wherein the at least one further frequency corresponds to an integer multiple of the first frequency.

The reference signal thus comprises a plurality of amplitude peaks at a plurality of frequencies, wherein the reference signal is preferably composed of a plurality of sinusoidal oscillations. The further frequencies may also be referred to as higher blade passing frequencies. For example, the second blade passing frequency is twice the first blade passing frequency. Preferably, the reference signal is composed of the first, second and third blade passing frequencies. Further preferably, the reference signal is composed of the first, second, third, and fourth blade passing frequencies. Further, for example, the reference signal may be composed of a plurality of multiples of the blade passing frequency.

According to the basic idea of the application, a pressure fluctuation generator for generating pressure fluctuations in a hydrodynamic system is proposed, in particular for a device for active reduction of pressure fluctuations according to any one of claims 1 to 3, comprising an oscillator and an actuator. The oscillator comprises a source area facing a pressure compartment of the hydrodynamic system, and to which a static pressure of the hydrodynamic system is applied to the source area. The oscillator is connected to the actuator, wherein the actuator is adapted to oscillate the source area by means of a control signal to apply pressure fluctuations to the hydrodynamic system. It is proposed that the pressure fluctuation generator comprises a back pressure chamber separated from the pressure compartment of the hydrodynamic system and from the ambient pressure, and the oscillator faces the back pressure chamber at the backside of the source area, wherein the back pressure chamber is gas-filled and a back pressure is present in the back pressure chamber which is matched to the static pressure in the pressure compartment.

By means of the back pressure chamber, the static pressure on the source area in the hydrodynamic system can be compensated so that the oscillator can be supported in a pressure-neutral manner. Accordingly, an oscillating motion about the neutral position is possible without further measures of the control of the actuator. The gas filling allows compression and expansion in the back pressure chamber during the oscillating motion of the oscillator. The gas in the back pressure chamber is, for example, nitrogen to achieve better expansion behavior.

The matched pressure results in a small deviation of the pressure in the back pressure chamber from the static pressure in the pressure compartment and allows sufficient compensation of the static pressure acting on the source area of the oscillator in the hydrodynamic system. Preferably, the back pressure in the back pressure chamber deviates by a maximum of +/- 20% from the static pressure in the pressure compartment. Furthermore, it is particularly preferred if the deviation of the pressure in the back pressure chamber from the static pressure in the pressure compartment and/or in the hydrodynamic system is at most +/- 10%, more preferably at most +/- 5%. Further, it is particularly advantageous if the pressure in the back pressure chamber and in the pressure compartment are the same.

Preferably, the pressure fluctuation generator comprises a control system which enables the back pressure in the back pressure chamber to be controlled or adjusted as a function of the static pressure in the pressure compartment.

In an advantageous embodiment, the oscillator is a piston. The source area is therefore preferably formed by an end face of the piston. A piston enables precise control of the pressure fluctuations inserted via the source area, since the piston comprises a low elasticity. The piston may also be referred to as a piston emitter.

In another advantageous embodiment, the oscillator is a diaphragm. The source area is therefore preferably formed by one side of the diaphragm.

In addition to diaphragms and pistons, other alternative oscillating end faces can in principle also be used as source areas.

In a preferred embodiment, the actuator of the pressure fluctuation generator is a Lorentz actuator. The mode of operation of a Lorentz actuator corresponds to the drive of an electrodynamic loudspeaker and comprises a voice coil. In this way, a particularly simple and inexpensive control is possible.

In an advantageous embodiment, the actuator of the pressure fluctuation generator is a piezoelectric actuator. This makes it possible to generate high actuating forces dynamically.

Furthermore, it is possible that the source area is actively driven by different, further actuators. These can be crank drives as well as hydraulic and pneumatic drives.

Furthermore, according to the basic idea of the application, a method for active reduction of pressure fluctuations in a hydrodynamic system by means of a device according to any one of claims 1 to 3 is proposed, wherein the controller unit receives a pressure fluctuation signal from the pressure sensor. It is proposed that the rotational speed of the pump is captured and received by the controller unit, wherein the controller unit generates a reference signal from the rotational speed of the pump, wherein the controller unit generates a control signal from the reference signal by means of an adaptive filter, and controls the pressure fluctuation generator with the control signal, wherein the controller unit continuously optimizes the adaptive filter to minimize the pressure fluctuation signal.

The method enables active control of the pressure fluctuation generator with an adaptive filter and very good adaptation in case of changes in the hydrodynamic system, for example due to opening or closing valves and/or a change in the pump speed, so that pressure fluctuations, in particular pressure fluctuations induced by the pump, can be compensated over a wide range of operation of the hydrodynamic system.

According to a further development, a method with a pressure fluctuation generator according to any one of claims 4 to 8 is proposed, wherein a respective pressure sensor measures the static pressure in the hydrodynamic system and in the counterpressure chamber, wherein the controller unit controls at least one valve connected to the back pressure chamber and adjusts the back pressure in the back pressure chamber to the static pressure in the hydrodynamic system.

This enables optimum operation of the pressure fluctuation generator and thus also of the device for active reduction of pressure fluctuations in a hydrodynamic system in the event of changes in the static pressure in the hydrodynamic system. Accordingly, changes in the static pressure in the hydrodynamic system do not interfere with the functioning of the pressure fluctuation generator due to the adjustment of the back pressure in the back pressure chamber. In this case, the adjustment is performed with respect to the static pressure, i.e. the averaged pressure, which is present independently of any short-term pressure fluctuations.

In possible embodiments, a corresponding device for active reduction of pressure fluctuations, a corresponding pressure fluctuation generator, and a corresponding method for active reduction of pressure fluctuations can also be used for active reduction of pressure fluctuations in a hydraulic system.

The invention is explained below with reference to preferred embodiments with reference to the accompanying figures. Thereby shows

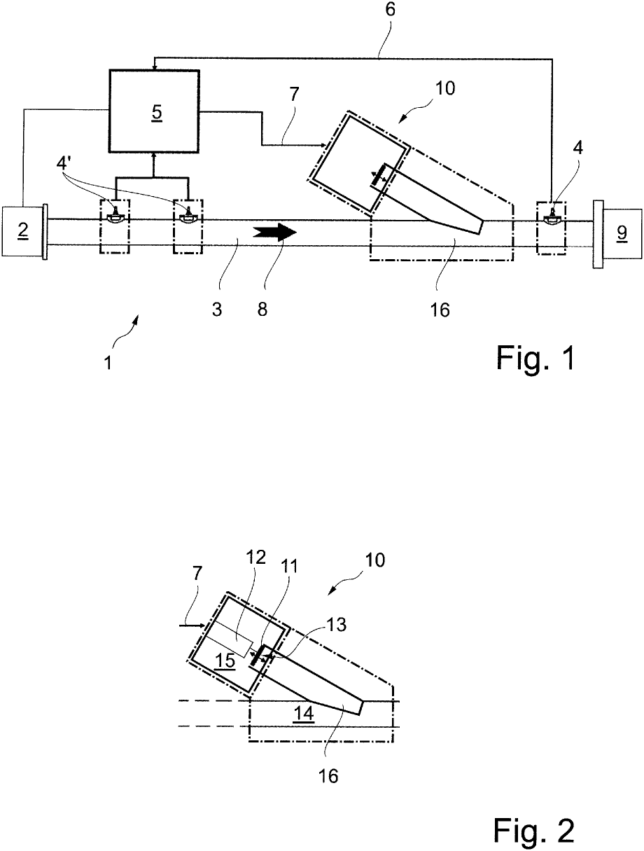

FIG. 1 a schematic illustration of a device for active reduction of pressure fluctuations in a hydrodynamic system; and

FIG. 2 a pressure fluctuation generator.

FIG. 1 shows an embodiment of a device 1 for active reduction of pressure fluctuations in a hydrodynamic system in a schematic illustration. Hydrodynamic systems can be open or closed, wherein only the zone between a pump 2 and a hydrodynamic component 9 is shown in the schematic illustration of FIG. 1. Therefore, the hydrodynamic system of the embodiment, in which the device 1 for active reduction of pressure fluctuations is integrated, can be either an open or a closed hydrodynamic system. The hydrodynamic component 9 may be one or more hydraulic elements, such as valves, hydraulic actuators, heating bodies, thermostats, etc., which are connected to the pump 2 via pipes 3. The pump 2 generates a static pressure in the hydrodynamic system as well as, depending on the hydrodynamic component 9, a volume flow with a flow direction 8. The hydrodynamic system can be, for example, the heating circuit of a residential building.

Pressure fluctuations are introduced into a hydrodynamic system, in particular by a pump 2, which propagate in the hydrodynamic system and excite the structure, in particular the pipes 3, to vibrate. Among other things, this can lead to undesirable acoustic emissions.

The device 1 for active reduction of pressure fluctuations comprises a pressure fluctuation generator 10, which selectively introduces pressure fluctuations into the hydrodynamic system to destructively interfere with the existing pressure fluctuations generated by the pump 2 and/or the hydrodynamic component 9.

The pressure fluctuation generator 10 is therefore hydraulically or hydrodynamically connected to the hydrodynamic system, which in the embodiment of FIG. 1 is done by means of a Y-shaped connecting piece 16.

Downstream of the connecting piece 16, a pressure sensor 4 is arranged on the pipe 3, which can capture the pressure fluctuations and thus temporally resolve the pressure in the pipe 3 of the hydrodynamic system accordingly. The pressure fluctuations are transmitted from the pressure sensor 4 as a pressure fluctuation signal 6 to a controller unit 5.

The controller unit 5 receives the rotational speed of the pump 2, which is captured by means of a rotational speed sensor. In this embodiment, the pump 2 comprises a number of blades of seven and an assumed rotational speed of 1450 revolutions per minute. The controller unit 5 captures the rotational speed, multiplies the rotational speed by the set number of blades and generates from this a sinusoidal reference signal with 169.2 Hz, which corresponds to the first blade passing frequency. Phase position and amplitude of the sinusoidal reference signal can have preset values in the controller unit 5.

In this advantageous embodiment, in addition to the first blade passing frequency, the second and third blade passing frequencies are also taken into account in the reference signal. Accordingly, further sinusoidal oscillations at 338.4 Hz and 676.8 Hz are modulated into the reference signal. Phase position and amplitude of the higher reference signal can have preset values in the controller unit 5, wherein the amplitude for the second and third blade passing frequency in the reference signal is preferably lower than the amplitude of the first blade passing frequency.

An adaptive finite impulse response filter is implemented in the controller unit 5, which filters the reference signal. The filtered reference signal is fed as a control signal 7 to a pressure fluctuation generator 10, which is controlled accordingly.

The pressure fluctuation generator 10 generates pressure fluctuations or pressure pulses which, starting from the source area 13, see also FIG. 2, propagate in the pressure compartment 14 along the wall of the pipe 3 and interfere in the connecting piece 16 with the pressure fluctuations in the hydrodynamic system, in particular with the pressure fluctuations induced by the pump 2.

The resulting pressure fluctuations are in turn captured by the pressure sensor 4 and transmitted to the controller unit 5 as a pressure fluctuation signal 6, thus providing feedback on the action of the pressure fluctuation generator 10. A continuous minimization process is performed in the controller unit 5, which minimizes the pressure fluctuation signal 6 as a target variable by varying the filter parameters of the digital adaptive FIR filter in the controller unit 5. Consequently, the filter parameters are varied according to the minimization process after a time interval has elapsed and the result is evaluated as the pressure fluctuation signal 6. Furthermore, the continuous optimization of the adaptive filter enables adaptation to the changes in the hydrodynamic system in which the device 1 is used for active reduction of pressure fluctuations. The changes in the filtering behavior of the adaptive filter is used, among other things, to adjust the phase and amplitude of the counter-pressure or pressure fluctuations generated by the pressure fluctuation generator 10. In possible alternative embodiments, the filter parameters may be fixed after an optimization phase.

Changes in or to the hydrodynamic system have a direct effect on the operational behavior of the pump 2 and thus on the pressure fluctuations it generates. Changes are, for example, the connection and disconnection of serial or parallel pipe lines with the hydrodynamic components 9 (e.g. heating bodies on or off) as well as their targeted throttling by adjusting the valve position. As a result of the changing system behavior of the hydrodynamic system, a permanent identification of the circuit and adaptation of the control parameters in the controller unit 5 for the actuator 12 is particularly advantageous, which is achieved by the adaptive filter and the optimization process.

Furthermore, in possible embodiments, further pressure sensors 4′ can optionally be used along a section of the pipe 3, which determine the direction of superimposed, counterpropagating pressure waves in the controller unit 5, so that the propagation directions of the pressure fluctuation components can be separated in a signal processor of the controller unit 5.

FIG. 2 shows an embodiment of a pressure fluctuation generator 10, which is also used in the embodiment of the device for active reduction of pressure fluctuations of FIG. 1.

The pressure fluctuation generator 10 comprises an oscillator 11 in the form of a piston or piston radiator, the end face of which, as a source area 13 in a connection pipe, points into the pressure compartment 14 in which the static pressure of the hydrodynamic system is applied. The connecting pipe leads into a y-shaped connecting piece 16, which can be inserted into the pipes 3 of a hydrodynamic system. The oscillator 11 is driven by an actuator 12, which in this embodiment is a Lorentz actuator and performs a control of the oscillator 11 by the control signal 7 using the Lorentz force. In possible embodiments, a transmission element may be used when a Lorentz actuator is used as an actuator 12.

The pressure fluctuation generator 10 comprises a back pressure chamber 15, which causes a static back pressure on the back side of the source area 13 exposed to the pressure compartment 14 and thus to the static pressure of the hydrodynamic system. The back pressure in the back pressure chamber thus balances the static pressure of the hydrodynamic system. In this way, the oscillator 11 can effectively generate pressure fluctuations and the actuator 12 is not loaded by a force of static pressure on the source area 13. The back pressure chamber 15 is filled with gas, preferably nitrogen, for ease of compression and expansion as the oscillator 11 displaces.

In this advantageous embodiment, the back pressure in the back pressure chamber 15 is adjusted to the static pressure of the hydrodynamic system or the static pressure in the pressure compartment 14, wherein the static pressure can be captured by means of a pressure sensor 4 and/or 4′ and can be tracked by the controller unit 5 by actuating corresponding valves, not shown. Accordingly, a piston emitter may, for example, be a cylinder in which a displaceable piston is mounted in a force-neutral manner as an oscillator 11 and is driven in a defined manner, for example, by means of a piezo element and/or a Lorenz actuator as an actuator 12.

When a piezo element is used as actuator 12, in possible embodiments a transmission element may be provided which operates according to the principle of the hydraulic transmission ratio.

1-10. (canceled)

11. A device for active reduction of pressure fluctuations in a hydrodynamic system comprising:
a pump,
a pressure fluctuation generator,
at least one pressure sensor
and a controller unit, wherein the controller unit is adapted to control the pressure fluctuation generator and receive a pressure fluctuation signal from the pressure sensor, wherein
the rotational speed of the pump can be captured and is receivable by the controller unit, wherein the controller unit is adapted to
to generate a reference signal from the rotational speed of the pump,
generate a control signal from the reference signal by means of an adaptive filter, and to control the pressure fluctuation generator with the control signal, wherein
the controller unit is adapted to continuously optimize the adaptive filter to minimize the pressure fluctuation signal.

12. The device according to claim 11, wherein the pump comprises a constant number of blades, wherein the controller unit is adapted to generate a reference signal comprising a first amplitude peak at a first frequency corresponding to the rotational speed multiplied by the number of blades.

13. The device according to claim 12, wherein the controller unit is adapted to generate a reference signal comprising, in addition to the first amplitude peak at the first frequency, at least one further amplitude peak at a further frequency, wherein the at least one further frequency corresponds to an integer multiple of the first frequency.

14. A pressure fluctuation generator for generating pressure fluctuations in a hydrodynamic system, comprising:
an oscillator and an actuator, wherein
the oscillator comprises a source area facing a pressure compartment of the hydrodynamic system and to which a static pressure of the hydrodynamic system is applied, wherein
the oscillator is connected to the actuator, wherein the actuator is adapted to oscillate the source area by means of a control signal to apply pressure fluctuations to the hydrodynamic system, wherein
the pressure fluctuation generator comprises a back pressure chamber separated from the pressure compartment of the hydrodynamic system and from the ambient pressure,
and the oscillator faces the back pressure chamber at backside of the source area,
wherein the back pressure chamber is gas-filled and a back pressure is present in the back pressure chamber which is matched to the static pressure in the pressure compartment.

15. The pressure fluctuation generator according to claim 14, wherein the oscillator is a piston.

16. The pressure fluctuation generator according to claim 14, wherein the oscillator is a diaphragm.

17. The pressure fluctuation generator according to claim 14, wherein the actuator is a Lorentz actuator.

18. The pressure fluctuation generator according to claim 14, wherein the actuator is a piezoelectric actuator.

19. A method for active reduction of pressure fluctuations in a hydrodynamic system by means of a device according to claim 11, wherein the controller unit receives a pressure fluctuation signal from the pressure sensor, wherein
the rotational speed of the pump is captured and received by the controller unit, wherein the controller unit generates a reference signal from the rotational speed of the pump, wherein
the controller unit generates a control signal from the reference signal by means of an adaptive filter, and controls the pressure fluctuation generator with the control signal, wherein
the controller unit continuously optimizes the adaptive filter to minimize the pressure fluctuation signal.

20. The method according to claim 19, comprising the use of a pressure fluctuation generator for generating pressure fluctuations in a hydrodynamic system, comprising:
an oscillator and an actuator, wherein
the oscillator comprises a source area facing a pressure compartment of the hydrodynamic system and to which a static pressure of the hydrodynamic system is applied, wherein
the oscillator is connected to the actuator, wherein the actuator is adapted to oscillate the source area by means of a control signal to apply pressure fluctuations to the hydrodynamic system, wherein
the pressure fluctuation generator comprises a back pressure chamber separated from the pressure compartment of the hydrodynamic system and from the ambient pressure, and the oscillator faces the back pressure chamber at backside of the source area, wherein the back pressure chamber is gas-filled and a back pressure is present in the back pressure chamber which is matched to the static pressure in the pressure compartment;
wherein a respective pressure sensor measures the static pressure in the hydrodynamic system and in the back pressure chamber, wherein the controller unit controls at least one valve connected to the back pressure chamber and adjusts the back pressure in the back pressure chamber to the static pressure in the hydrodynamic system.
